(19) United States
(12) Patent Application Publication
(10) Pub. No.: US 2005/0007453 A1
(43) Pub. Date: Jan. 13, 2005

(54) Method and system of simultaneously displaying multiple views for video surveillance

(76) Inventor: Yavuz Ahiska, Esher (GB)

Correspondence Address: SAWYER LAW GROUP LLP, P.O. Box 51418, Palo Alto, CA, 94303, US

(21) Appl. No.: 10/837,019

(22) Filed: Apr. 30, 2004

Related U.S. Application Data
(60) Provisional application No. 60/467,644, filed on May 2, 2003.

(51) Int. Cl. H04N 7/18

(52) U.S. Cl. 348/143

(57) ABSTRACT

The method and system of transmitting a plurality of views from a video camera is disclosed. The method and system comprises capturing a plurality of views from the camera and scaling the plurality of views to a specified size within the camera. The method and system also comprises compositing at least a portion of the plurality of views into one or more views within the camera. The method and system further comprises transmitting one or more of the views from the video camera to a base station and compositing views from the camera into a single view within the base station.

### RELATED APPLICATIONS

The present invention is related to the following copending U.S. patent applications:

U.S. patent application, Ser. No. ______ (Attorney Docket No. 2823P), entitled “Correction of Optical Distortion by Image Processing”, filed on even date herewith and assigned to the assignee of the present invention.

U.S. patent application, Ser. No. ______ (Attorney Docket No. 2838P), entitled “Multiple View Processing in Wide-Angle Video Camera”, filed on even date herewith and assigned to the assignee of the present invention.

U.S. patent application, Ser. No. ______ (Attorney Docket No. 2839P) entitled “Multiple Object Processing in Wide-Angle Video Camera”, filed on even date herewith and assigned to the assignee of the present invention.

### FIELD OF THE INVENTION

The present invention relates generally to video camera providing composit multiple views for better video surveillance.

### BACKGROUND OF THE INVENTION

It is desirable to provide multiple views for video surveillance. Accordingly, what is needed is a system and method for simultaneously providing multiple views. The present invention addresses such a need.

### SUMMARY OF THE INVENTION

The method and system of compositing a plurality of views from a video camera is disclosed. The method and system comprises capturing a plurality of views from the camera and scaling the plurality of views to a specified size within the camera. The method and system also comprises compositing at least a portion of the plurality of views into one or more views within the camera. The method and system further may transmit one or more of the views from the video camera to a base station which may display the composit view generated in the camera or composing views from the camera converted into a single view within the base station.

### BRIEF DESCRIPTION OF THE DRAWINGS

FIG. 1 illustrates a wide-angle camera in accordance with the present invention.

FIG. 2 illustrates one embodiment of the present invention.

FIG. 3 illustrates a second embodiment of the present invention.

FIG. 4 illustrates a third embodiment of the present invention.

FIG. 5 illustrates a fourth embodiment of the present invention.

### DETAILED DESCRIPTION

The present invention relates generally to video cameras and more particularly to providing multiple views utilizing such cameras. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

In copending application, Ser. No. ______ (Attorney Docket No. 2838 P), entitled “Multiple View Processing in Wide-Angle Video Camera”, a camera is capable of supplying multiple views of different areas under surveillance. In typical use one view may represent a wide-angle view of the scene while another represents a close-up view of a region of interest. In normal operation these views, and similar views from other cameras, must be presented to an operator in a concise manner. This usually entails compositing the various views into a single view for display on a monitor. A useful example might be a close-up of a region of interest filling most of the display and a smaller thumbnail wide-angle view to ensure that events in other areas are not missed.

Under different scenarios it may be better to perform this compositing in the camera or at the base station where the views are monitored. If the base station is not compatible with cameras that can produce multiple views then it is necessary to perform all compositing in the camera. If the bandwidth between the camera and the base station is limited it may be beneficial to perform compositing in the camera in order to reduce the amount of data transmitted. If, however, more than one base station requests views from the same camera it may be possible to reduce the amount of data transmitted by broadcasting the same view to all base stations that have requested it. If a base station ahs requested views from ore than one camera then it is necessary that the base station composites the views, although each camera may be supplying composit views and the base station builds a composit of composites. In general, it is useful to be able to determine where compositing takes place moment by moment.

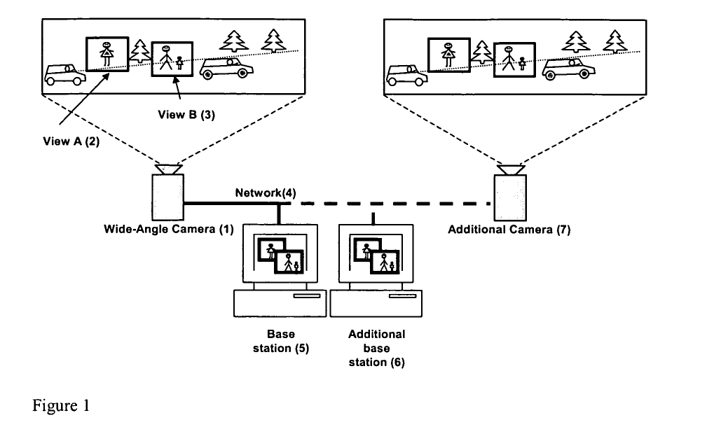

Referring to FIG. 1A, a wide-angle camera 1 captures a scene and extracts several views 2 & 3. The camera scales the views as necessary, optionally composites the views into a one or more frames and transmits them to the base station 5. At the base station separate views or frames may be composited to present a single frame to the operator. If more then one base station is present on the network 6 the camera may be asked to supply the same or different views each base station. If more then camera is present on the network a base station may be request views from more than one camera.

In one embodiment referred to in FIG. 1B, the composit view from the camera may be made output in a standard analog form for monitoring on a standard video monitor.

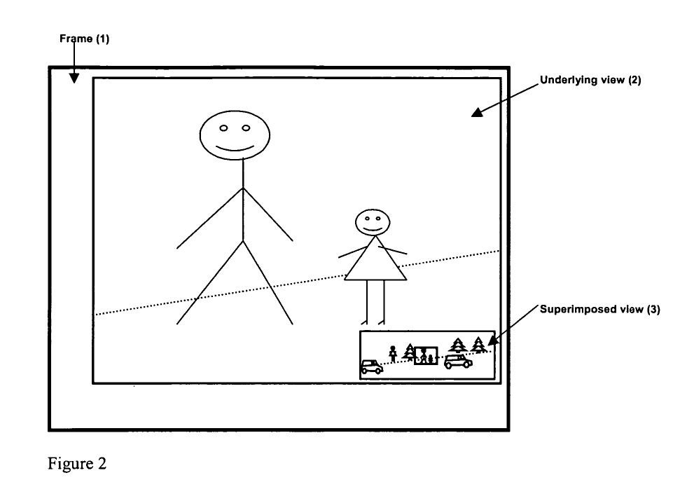

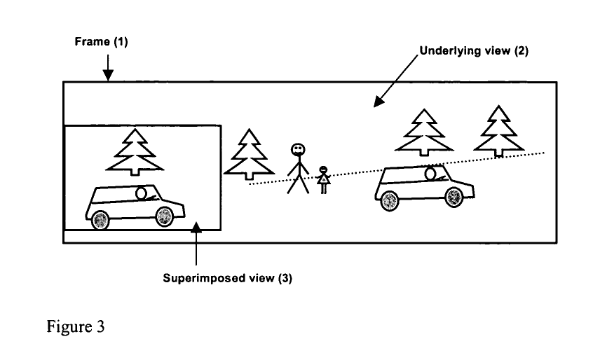

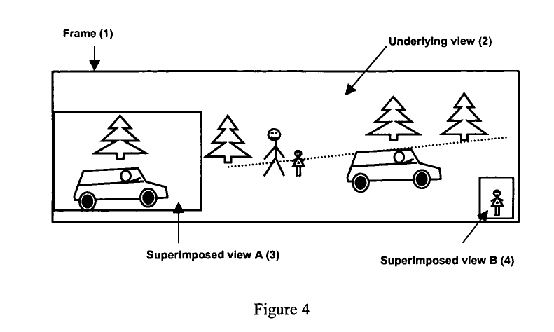

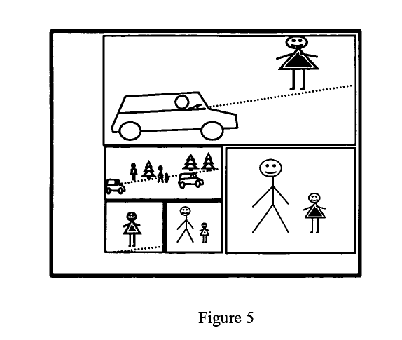

In one embodiment shown in FIG. 2 a close-up view, the underlying view 2, may fill the whole frame 1 other than a small region occupied by a thumbnail holding the wide-angle view, the superimposed view 3. In another embodiment shown in FIG. 3 the underlying view 2 is a wide-angle view and the close-up 3 is superimposed upon it. In yet another embodiment shown in FIG. 4 there may be several superimposed views 3 & 4 over an underlying view 2 within the same frame 1. In a further embodiment shown in FIG. 5 the distinct views may not overlap one another and so no part of any view is obscured. Those skilled in the art will understand that the size of the superimposed views may be varied as may their quantity, position, and size within the frame and that these parameters may be varied under control of the base station or by the camera itself. In particular, the position may be varied to prevent the thumbnail from obscuring points of interest within the underlying view.

In an alternative embodiment each of the above arrangements or a single view filling a frame may be alternated in time, the time between alternate arrangements to be determined by the base station or the camera.

The foregoing has described methods for the display of multiple views within a surveillance system that are given for illustration and not for limitation. Thus the invention is to be limited only by the appended claims.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method of transmitting a plurality of views from a video camera comprising:
(a) capturing a plurality of views within said camera where one view is a wide angle view;
(b) scaling the plurality of views to a specified size within said camera where one view is a geometry corrected wide-angle view or a region of it;
(c) compositing at least a portion of the plurality of views into one or more views within said camera;

2. The method of claim 1 in which one or more views from said video cameras transmitted on a network to a single or multiple base stations.

3. The method of claim 2 in which the one or more views from said video camera is composited into a single view within said base station.

4. The method of claim 1 in which one view underlies other superimposed views and said underlying view is a wide-angle and said superimposed views are close-up.

5. The method of claim 1 in which one view underlies other superimposed views and said underlying view is a close-up and said superimposed views are wide-angle.

6. The method of claim 1 in which views are tiled such that one does not obscure another.

7. The method of claim 1 in which views are tiled such that some may obscure others.

8. The method of claim 1 in which the quantity, size, and position of views within the composit frame is determined by said camera.

9. The method of claim 2 in which the quantity, size and position of views a within said composited frame is determined by said base station.

10. The method of claim 3 in which the base station requests said views from more than one camera and composites said views.

11. The method of claim 3 in which said camera broadcasts some or all of said views to a plurality of base stations.

12. The method of claim 11 in which the camera scales a view to a single size a and broadcasts it and said base stations complete scaling to said required size.

13. The method of claim 1 in which parameters that control said composition in camera.

14. The method of claim 2 in which parameters that control said compositing in base station may change with time.

15. A video camera capable of transmitting a plurality of views comprising:
means for capturing a plurality of views within said camera where one view may represent a wide-angle view;
means for scaling said plurality of views to a specified size within said camera where one view is a geometry corrected wide-angle view or a region of it;
means for compositing at least a portion of said plurality of views into one or more views within said camera;
means of output circuitry capable of outputting said plurality of views.

16. The camera of claim 15 in which the one or more views from said video camera is transmitted on a network to a single or multiple base stations.

17. The camera of claim 15 in which the one or more views from said video a camera is transmitted on a network to a single or multiple base stations.

18. The camera of claim 15 in which one view underlies other superimposed views and said underlying view is a wide-angle and said superimposed views are close-up.

19. The camera of claim 15 in which one view underlies other superimposed views and said underlying view is a close-up and said superimposed views are wide-angle.

20. The camera of claim 15 in which views are tiled such that one does not obscure another.

21. The camera of claim 15 in which views are tiled such that some may obscure others.

22. The camera of claim 15 in which said quantity, size, and position of views within said composited frame is determined by said camera.

23. The camera of claim 16 in which said quantity, size, and position of views a within said composited frame is determined by said base station.

24. The camera of claim 16 in which said base station requests said views from more than one camera and composites said views.

25. The camera of claim 16 in which said camera broadcasts some or all of said views to a plurality of base stations.

26. The camera of claim 25 in which said camera scales a view to a single size and broadcasts it and said base stations complete scaling to said required size.

27. The camera of claim 16 in which parameters that control said compositing in camera and or base station may change with time.
